(19) United States
(12) Patent Application Publication
(10) Pub. No.: US 2022/0318234 A1
(43) Pub. Date: Oct. 6, 2022

(54) SYSTEM AND METHOD FOR PROVIDING NATURAL LANGUAGE PROCESSING

(71) Applicant: Pranav Sharma, Ilford (GB)

(72) Inventor: Pranav Sharma, Ilford (GB)

(21) Appl. No.: 17/220,957

(22) Filed: Apr. 2, 2021

(51) Int. Cl. G06F 16/242; G06F 40/205; G06N 20/00

(52) U.S. Cl. CPC G06F 16/243; G06F 40/205; G06N 20/00

(57) ABSTRACT

The system and method of present invention provides natural language processing of queries associated with one or more domains via individually configurable decentralized AI-based scalable units leading to flexibility in scaling and descaling. In operation, the present invention provides for hosting NLP resources configurable to perform natural language processing of queries and generate responses associated with respective domain. Each NLP resource comprises logically independent AI-based units. Each AI-based unit is configurable to perform processing of queries and emulate responses associated with respective subdomain of the domain of corresponding NLP resource. Further, each AI-based unit comprises respective one or more AI-based micro-units configurable to perform processing of queries and emulate responses associated with respective one or more topics of the subdomains of corresponding AI-based unit. Further the present invention provides for performing natural language processing of incoming query and generating a response via NLP resources.

### FIELD OF THE INVENTION

The present invention relates generally to the field of natural language processing. More particularly, the present invention relates to a system and a method for providing natural language processing via decentralized artificial intelligence based scalable units.

### BACKGROUND OF THE INVENTION

In the past few years artificial intelligence has evolved at a great pace with the aim to reduce human effort and provide near human like expertise in various fields. One such field where artificial intelligence is implemented to provide human like expertise is Natural Language Processing (NLP). NLP facilitates understanding of natural human language by a computing device and generation of automated responses based on the understanding of human language by said computing device using artificial intelligence.

Recent advances in NLP has led to the development of conversational-bot based user-interfaces for integration with various enterprise applications associated with one or more domains such as banking, health-care, ecommerce etc. where conversational-bots are deployed to understand natural human language queries and generate automated responses to the queries. Most of the said conversational-bots are implemented using a monolithic architecture, wherein a single conversational-bot is modelled with entire knowledge and skill associated with the domain. However, natural language queries from customers of any large enterprise are diverse and complex, and therefore, the conversational-bot requires constant scaling for addition of any new topic or sub-domain associated with the domain. For instance, for a banking domain, addition of a new sub-domain such as payments or addition of a new topic to the payment sub-domain, such as, but not limited to, Bill Payments, Direct Debit etc. is extremely complex and time consuming in a broad monolithic architecture. Further, the addition of a new “intent for a new topic” to enable the conversational-bot to respond to one or more queries associated with said new topic requires expensive regression testing of all earlier topics. Furthermore, the development of conversational-bots using monolithic architecture is slow, further leading to increased time to model the depth and breadth of relevant domain of the enterprise.

In another implementation of conversational-bots based on an agent-master architecture, a conversational-bot further comprises multiple artificial intelligence (AI) based bots, and one of the multiple AI bots is configured to act as a master to the other AI bots. In the implementation using agent-master architecture, it has been observed that the conversational-bot reacts well enough only for predefined types of conversations, and therefore require constant training. However, the agent-master architecture poses several challenges during upscaling or downscaling of the conversational bot, as the addition of a new capability requires redeployment of the entire system or the master-bot. Further, the addition of new skills to the master-bot requires modelling effort along with extensive regression testing as the new skill can easily impact the existing skills.

In addition to the abovementioned drawbacks, the existing conversational-bots deployed using monolithic architecture or an agent-master architecture provide limited capability to leverage the various sub-fields (including Question and Answer system, Abstractive Summarization, Semantic Search, Knowledge Graph etc.) of Natural Language Processing (NLP). Further, the aforementioned architectures are unable to support a federated build, further reducing agility in large scale industrial deployments which require support from multiple independent product and engineering teams. Yet further, the existing conversational-bots lack accuracy as they cannot be scaled beyond a certain point.

In light of the above drawbacks, there is a need for a system and method which provides natural language processing via decentralized Artificial Intelligence (AI) based scalable units. There is need for a system and method which provides a federated design using multiple independent AI based units. Further, there is a need for a system and method which facilitates upscaling/downscaling with minimal effort without affecting the capability of the entire system. Furthermore, there is a need for a system and a method which can effectively leverage various sub-fields of NLP. Yet further, there is need for a system and a method which accurately interprets human language queries and accordingly generates accurate responses. Yet further, there is a need for a system and a method which can support multi-turn conversation. Yet further, there is a need for a system and a method which can be easily integrated with any standard enterprise application for supporting automated conversations.

### SUMMARY OF THE INVENTION

In accordance with various embodiments of the present invention, a method for providing natural language processing of queries associated with one or more domains is provided. The method is implemented by at least one processor executing program instructions stored in a memory. The method comprises hosting one or more Natural Language Processing (NLP) resources. Each NLP resource is configurable to perform natural language processing of queries associated with respective one or more domains and emulate responses associated with the respective one or more domains. Each NLP resource comprises logically independent one or more AI-based units. Each AI-based unit is individually configurable to perform natural language processing of queries and emulate responses associated with respective one or more subdomains further associated with the one or more domains of the corresponding NLP resource, such that individual configuring of the one or more AI-based units causes the configuring of the corresponding NLP resource without affecting overall configuration of the corresponding NLP resource. Further, the present invention provides for performing natural language processing of an incoming query and generating a response via the one or more NLP resources.

In accordance with various embodiments of the present invention, a system for providing natural language processing of queries associated with one or more domains is provided. The system comprises a memory storing program instructions, a processor configured to execute program instructions stored in the memory, and a natural language processing engine executed by the processor, and configured to host one or more Natural Language Processing (NLP) resources. Each NLP resource is configurable to perform natural language processing of queries associated with respective one or more domains and emulate responses associated with the respective one or more domains. Each NLP resource comprises logically independent one or more AI-based units. Each AI-based unit is individually configurable to perform natural language processing of queries associated with respective one or more subdomains further associated with the one or more domains of the corresponding NLP resource and emulate responses associated with the respective one or more sub-domains based on the natural language processing, such that individual configuring of the one or more AI-based units causes the configuring of the corresponding NLP resource without affecting overall configuration of the corresponding NLP resource. Further, the system of the present invention performs natural language processing of an incoming query and generate a response via the one or more NLP resources.

In accordance with various embodiments of the present invention, a computer program product is provided. The computer program product comprises a non-transitory computer-readable medium having computer-readable program code stored thereon, the computer-readable program code comprising instructions that, when executed by a processor, cause the processor to host one or more Natural Language Processing (NLP) resources. Each NLP resource is configurable to perform natural language processing of queries associated with respective one or more domains and emulate responses associated with the respective one or more domains. Each NLP resource comprises logically independent one or more AI-based units. Each AI-based unit is individually configurable to perform natural language processing of queries associated with respective one or more subdomains further associated with the one or more domains of the corresponding NLP resource and emulate responses associated with the respective one or more sub-domains based on the natural language processing, such that individual configuring of the one or more AI-based units causes the configuring of the corresponding NLP resource without affecting overall configuration of the corresponding NLP resource. Further, natural language processing of an incoming query is performed and a response is generated via the one or more NLP resources.

### BRIEF DESCRIPTION OF THE ACCOMPANYING DRAWINGS

The present invention is described by way of embodiments illustrated in the accompanying drawings wherein:

FIG. 1 is a block diagram of a computing environment including a system for providing natural language processing of queries associated with various domains, in accordance with various embodiments of the present invention;

FIG. 1A illustrates a detailed block diagram of a system for providing natural language processing of queries associated with various domains, in accordance with an embodiment of the present invention;

FIG. 1B illustrates a block diagram of a Natural Language Processing Resource(NLPR), in accordance with an embodiment of the present invention;

FIG. 1C illustrates a block diagram of artificial intelligence based unit, in accordance with an embodiment of the present invention;

FIG. 2 is a flowchart illustrating a method for providing natural language processing of queries associated with various domains, in accordance with various embodiments of the present invention; and

FIG. 3 illustrates an exemplary computer system in which various embodiments of the present invention may be implemented.

### DETAILED DESCRIPTION OF THE INVENTION

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention. The term “natural language query” as used in the specification refers to any incoming query in the natural language of the user. For example, any sentence in English or other supported languages is a natural language query. The term “Utterance” as used in the specification refers to anything a user says. The natural language query is an utterance. For example, if a user types “show me yesterday's financial news”, the entire sentence is the utterance. Another example may be “I want to make a payment”, “I am looking to pay Bob” or “I want to pay my rent”, the entire sentence is an utterance. The term “Intent” as used in the specification refers to user's intention derived from the utterance. For example, if a user types “show me yesterday's financial news”, the user's intent is to retrieve a list of financial headlines. In another example, if a user types “I want to pay Bob”, the user's intent is to make a payment. Intents refers to a name, often a verb and a noun, such as “showNews”, “makepayment”. The term “entity” as used in the specification refers to information present in the utterance that modifies an intent. For example, if a user types “show me yesterday's financial news”, the entities are “yesterday” and “financial”. In another example, if a user types “I want to pay Bob”, the entity is payee's name “Bob”. The term “Context” as used in the specification is a collection of intents and entities during a user's session/conversation with the system. For example, if a user types “I want to pay Bob”, the context is “makepayment” and “Bob”. The term “Natural Language Processing (NLP)” as used in the specification refers to the process of examining an utterance (query) and extracting the intent and entities from the utterance to provide a response. The variables “n” and “N” as used in the specification are positive integers. The terms “in scope” and “non-out of scope” have been used interchangeably. The term “human-like” responses as used in the specification refers to natural language responses that a human would reply with for a query.

The present invention discloses a system and a method for providing natural language processing. In particular, the present invention discloses a system and a method for providing natural language processing of queries associated with one or more domains via decentralized artificial intelligence based scalable units, leading to flexibility in scaling and descaling of the system. The present invention may be utilized for building Polyglot, Omni Channel and Industrial grade Natural Language Interfaces. In operation, the present invention provides for hosting one or more natural language processing resources configurable to perform natural language processing of queries associated with respective one or more domains and emulate human-like responses associated with the respective one or more domains. In particular, each of the one or more natural language processing resources comprises logically independent one or more Artificial Intelligence (AI) based units individually configurable to perform natural language processing of queries and emulate human-like responses associated with respective one or more subdomains further associated with the one or more domains of the corresponding NLP resource, and together perform natural language processing of queries and emulate human-like responses associated with the corresponding domain. Each of the one or more AI-based units further comprise independent one or more AI-based micro-units individually configurable to perform natural language processing of queries and emulate human-like responses associated with respective one or more topics associated with the one or more subdomains of the corresponding AI-based unit, and together perform natural language processing of queries and emulate human-like responses associated with the corresponding sub-domain. Each of the one or more AI-based units and AI-based micro-units are connected with corresponding natural language processing resource using adapter patterns. Further, the present invention provides for generating a system meta-data including at least the domain of each of the one or more natural language processing resources. The present invention further provides for generating one or more databases including details of the one or more AI-based units and associated AI-based micro-units of respective natural language processing resource. Further, the present invention provides for identifying one of the one or more Natural Language Processing (NLP) resources for processing an incoming query from a user based on a mapping between an information embedded in the query and the system meta-data. Subsequently, the present invention provides for processing the incoming query and generating a response to the query via one or more AI-based unit(s) of the identified NLP resource, selected based on at least one of: the one or more databases, a broadcast and select technique; and a search, multicast and select technique.

The present invention would now be discussed in context of embodiments as illustrated in the accompanying drawings.

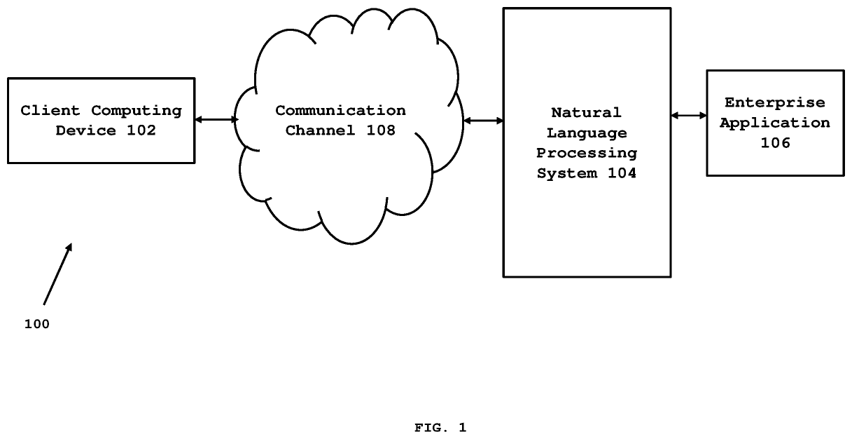

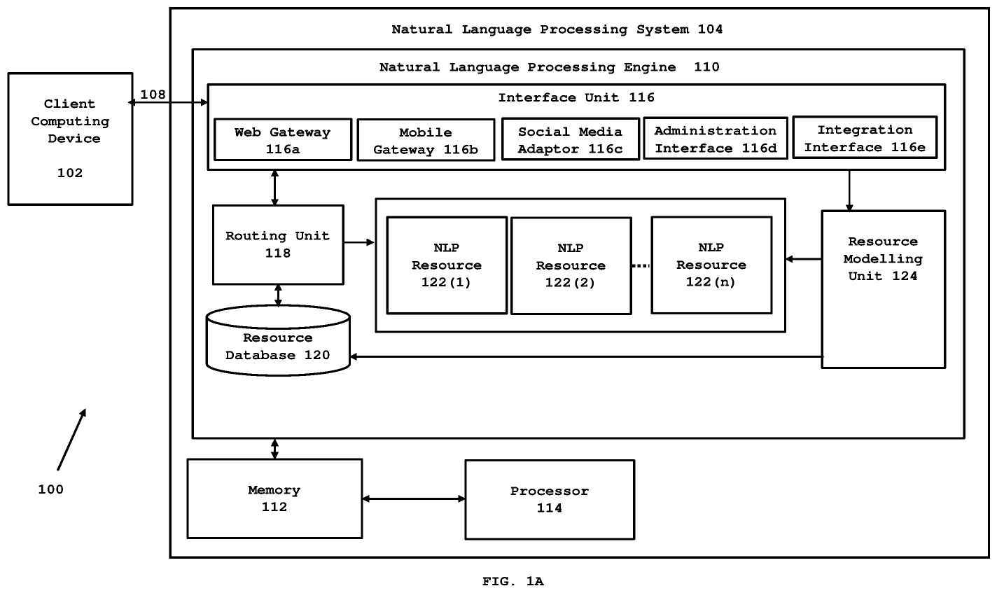

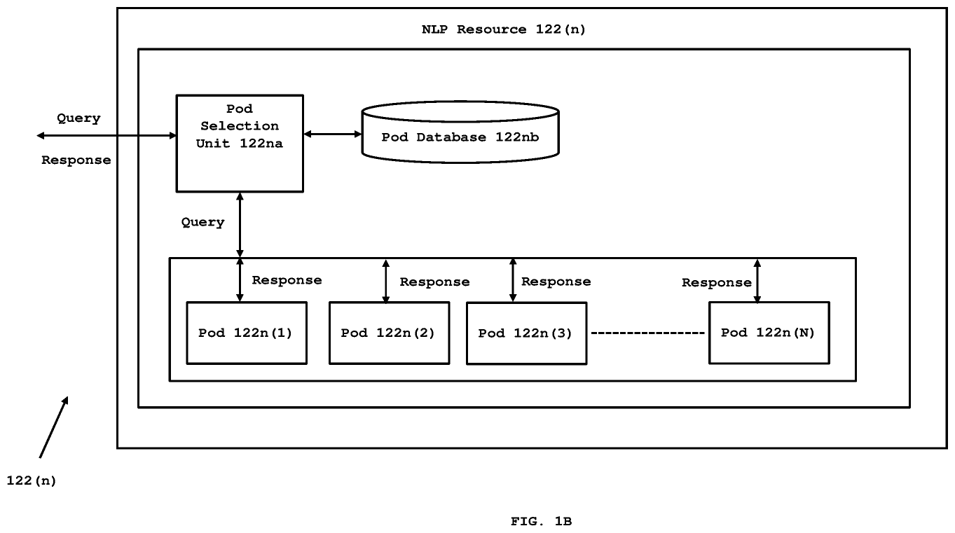

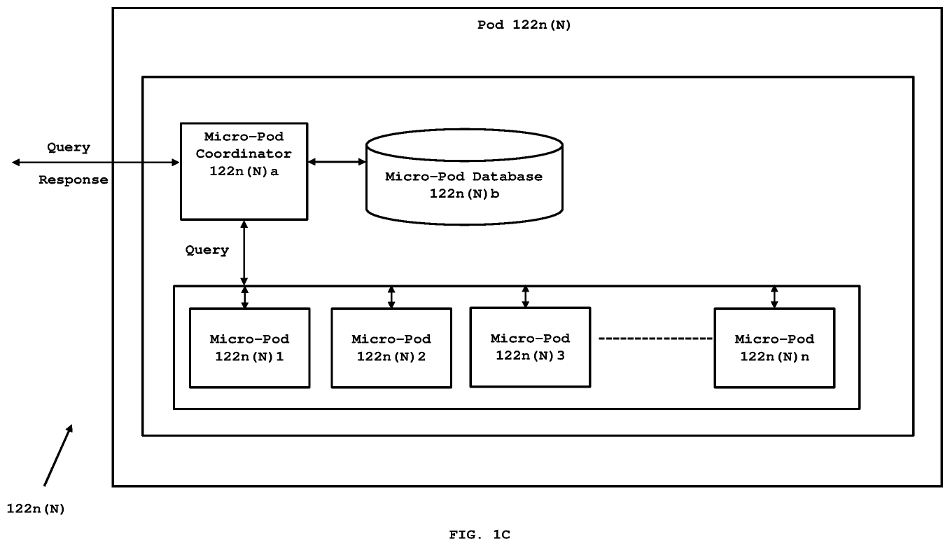

Referring to FIG. 1 a block diagram of a computing environment including a system for providing natural language processing of queries associated with various domains, in accordance with various embodiments of the present invention is illustrated. As shown, in FIG. 1, the computing environment includes a client computing device 102, a system providing natural language processing herein after referred to as Natural Language Processing (NLP) system 104, and an enterprise application 106.

In accordance with various embodiments of the present invention, the client computing device 102 may be a general purpose computer such as desktop, notebook, smartphone and tablets; a super computer; a microcomputer or any other device capable of executing instructions, connecting to a network and sending/receiving inputs. In an embodiment of the present invention, the client computing device 102 is configured to interface with the Natural Language Processing (NLP) system 104 over a network via multiple channels to input queries associated with one or more domains and receive a response. Examples of multiple channels may include, but are not limited to, web, mobile interface, Interactive Voice Response (IVR), WhatsApp, Apple Business Chat (ABC) and Facebook Messenger (FBM). In an embodiment of the present invention, the client computing device 102 interfaces with NLP system 104 to process natural language requests/queries and obtain automated responses via the NLP system 104.

In accordance with various embodiments of the present invention, the enterprise application 106 is a software application offering services related to one or more domains. Examples of domain may include, but are not limited to, banking services, payment services, shopping and ecommerce service, health care services etc. Each of the domains may be further sub-divided into sub-domains, and each sub-domain may be divided into one or more topics. In an embodiment of the present invention, the enterprise application may be a mobile application or a web application. In an embodiment of the present invention, the enterprise application 106 may be hosted by a server computer. In an embodiment of the present invention, a user interface of the enterprise application 106 may be implemented as a web interface accessible using a domain name or a mobile module. In an embodiment of the present invention, the client computing device 102 is configured with a mobile module of the enterprise application 106 to interface with the NLP system 104. In an embodiment of the present invention, the mobile module of the enterprise application 106 configures a User Interface (UI) on the client computing device 102 to input request/queries associated with the one or more domains for processing by the NLP system 104.

In accordance with various embodiments of the present invention, the Natural Language Processing (NLP) system 104 may be a software executable by a computing device or a combination of software and hardware. In an embodiment of the present invention as shown in FIG. 1, the NLP system 104 is a combination of software and hardware. In an embodiment of the present invention, the NLP system 104 may be implemented using a client-server architecture, wherein the client computing device 102 and/or the enterprise application 106 accesses a server hosting the NLP system 104 over a communication channel 108. Examples of the communication channel 108 may include, but are not limited to, an interface such as a software interface, a physical transmission medium such as a wire, or a logical connection over a multiplexed medium such as a radio channel in telecommunications and computer networking. Examples of radio channel in telecommunications and computer networking may include, but are not limited to, a Local Area Network (LAN), a Metropolitan Area Network (MAN), and a Wide Area Network (WAN).

In another embodiment of the present invention, the NLP system 104 may be implemented in a cloud computing architecture in which data, applications, services, and other resources are stored and delivered through shared data-centers. In an exemplary embodiment of the present invention, the functionalities of the NLP system 104 are delivered as Software as a Service (SAAS) to the client computing device 102 and/or the enterprise application 106. In an exemplary embodiment of the present invention, the NLP system 104 is a remote resource implemented over the cloud and accessible for shared usage in a distributed computing architecture by various enterprise applications 106 servicing multiple domains. In particular, the enterprise application 106 may access the functionalities of NLP system 104 over cloud to service natural language queries received at the user-end of the enterprise application 106.

In an embodiment of the present invention as shown in FIG. 1, the NLP system 104 is configured to interface with the enterprise application 106 using a software interface. The NLP system 104 may be integrated with the enterprise application 106 using API interface, Salesforce, service now, SAP etc. Further, the human language queries from the client computing device 102 installed with the mobile module (not shown) of the enterprise application 106 are directed towards the NLP system 104 for processing.

Referring to FIG. 1A, a detailed block diagram of the Natural Language Processing (NLP) system 104 is illustrated, in accordance with an embodiment of the present invention. The NLP system 104 comprises a Natural Language Processing engine 110, a memory 112, and a processor 114. The Natural Language Processing engine 110 is operated via the processor 114 specifically programmed to execute instructions stored in the memory 112 for executing functionalities of the Natural Language Processing engine 110 in accordance with various embodiments of the present invention. In an embodiment of the present invention, the memory 112 may be partitioned into a Random Access Memory (RAM), a Read-only memory (ROM) and hard drive disk (HDD).

In accordance with various embodiments of the present invention, the Natural Language Processing engine 110 configured to host one or more Natural Language Processing (NLP) Resources comprising independent AI-based units and AI-based micro-units, together configured to perform natural language processing of queries and emulate human-like responses associated with one or more domains. The Natural Language Processing engine 110 is further configured to receive natural language queries, route queries to one or more NLP Resources, process natural language queries via AI-based units or micro-units, analyze responses and provide the generated responses to the client. Further, the Natural Language Processing engine 110 is configured to receive admin requests for modelling respective AI-based units and AI-based micro-units. In an embodiment of the present invention, the Natural Language Processing engine 110 is a self-learning engine.

In accordance with various embodiments of the present invention, the Natural Language Processing engine 110 comprises an interface unit 116, a routing unit 118, a resource database 120, one or more Natural Language Processing Resources 122(1), 122(2) . . . 122(n), and a resource modelling unit 124. The various units of the Natural Language Processing Engine 110 are operated via the processor 114 specifically programmed to execute instructions stored in the memory 112 for executing respective functionalities of the multiple units (116, 118, 120, 122 and 124) in accordance with various embodiments of the present invention.

In various embodiments of the present invention, the interface unit 116 is configured to facilitate communication with the client computing device 102, the enterprise application 106, and the admin input/output device (not shown). In an embodiment of the present invention, the interface unit 116 is configured to provide interfacing with the client computing device 102 over a communication channel 108. In an embodiment of the present invention, the interface unit 116 is configured to provide interfacing and/or integration with one or more enterprise applications 106 servicing one or more domains using a software interface. In operation, the interface unit 116 is configured with a web gateway 116a, a mobile gateway 116b, a social media adaptor 116c, an administration interface 116d and an integration interface 116e. In an exemplary embodiment of the present invention, the administration interface provides communication with Input/output (I/O) devices(not shown) for receiving system configuration and updates from system admins. Further, the integration interface 116e is configured with one or more APIs such as REST and SOAP APIs to facilitate smooth interfacing with one or more enterprise applications 106.

In an embodiment of the present invention, the interface unit 116 includes a graphical user interface (not shown) accessible on the client computing device 102 to facilitate user interaction. In an exemplary embodiment of the present invention, the graphical user interface allows a user to create login credentials, select one or more domains, input queries/requests, receive personalized suggestions during inputting of queries/requests and receive responses to the input queries/requests. In an embodiment of the present invention, the graphical user interface associated with the interface unit 116 may be accessed from the client computing device 102 through a web gateway. In another embodiment of the present invention, the interface unit 116 is accessible by the client computing device 102 via a mobile gateway using a software module(not shown) installable on client computing device 102. In an exemplary embodiment of the present invention, the software module is capable of integration with enterprise application 106.

In various embodiments of the present invention, the interface unit 116 is configured to receive requests/queries associated with one or more domains from the client computing device 102, where the requests/queries are in natural human language. In various embodiments of the present invention, the interface unit 116 is configured to receive admin requests for modelling and hosting one or more Natural Language Processing (NLP) resources 122(1), 122(2) . . . 122(n) for providing Natural language processing of human language queries associated with one or more domains. In an embodiment of the present invention as shown in FIG. 1, the interface unit 116 is configured to receive admin requests for modelling the one or more NLP resources 122(1), 122(2) . . . 122(n) as per the one or more domains serviced by the enterprise application 106.

In accordance with various embodiments of the present invention, the routing unit 118 is configured to receive human language queries from the interface unit 116. The routing unit 118 is configured to maintain a system meta-data including details of each of the one or more NLP resources 122(1), 122(2) . . . 122(n). In an embodiment of the present invention, the details in the system meta-data includes, but is not limited to, names of each of the one or more NLP resources, domain of each of the one or more NLP resources, resource identifiers of each of the one or more NLP resources, identifiers of channels supported (web, mobile interface, Interactive Voice Response (IVR), WhatsApp, Apple Business Chat (ABC) and Facebook Messenger (FBM)), serving matrix, resilience rating for each of the one or more NLP resources 122(1), 122(2) . . . 122(n), data classification ratings of each of the one or more NLP resources 122(1), 122(2) . . . 122(n). In operation, the routing unit 118 is configured to maintain system meta-data in the resource database 120.

In accordance with various embodiments of the present invention, the routing unit 118 is configured to identify one of the one or more natural language processing resources 122(1), 122(2) . . . 122(n) for processing a query received from a user based on the system meta-data. In an embodiment of the present invention, the routing unit 118 is configured to identify one of the one or more NLP Resources 122(1), 122(2) . . . 122(n) based on a mapping between the query domain and the domain of the NLP resource using the system meta-data. Further, the routing unit 118 is configured to route the natural language query to the identified NLP resource out of the one or more NLP resources 122(1), 122(2) . . . 122(n). In another embodiment of the present invention, the routing unit 118 is configured to identify one of the one or more NLP resources 122(1), 122(2) . . . 122(n) based on a mapping between the resource identifier embedded in the received query and the resource identifier associated with the one or more NLP resources 122(1), 122(2) . . . 122(n) in the system meta-data. In an exemplary embodiment of the present invention, the software module (not shown) of the interface unit 116 installable on the client computing device 102 comprises resource identifiers of the one or more NLP resources 122(1), 122(2) . . . 122(n). Further, the software module enables embedding of the resource identifier with the query. It is to be understood that the working of the present invention is not limited to association of resource identifier with the query.

In accordance with various embodiments of the present invention, one of the identified NLP resource out of the one or more NLP resources 122(1), 122(2) . . . 122(n) is configured to receive the natural language query from the routing unit 118 for processing. In an exemplary embodiment of the present invention, NLP resource 122(n) is the identified NLP resource. Further, the identified NLP resource 122(n) is configured to perform natural language processing of the natural language query and provide appropriate responses to the query as explained with reference to FIGS. 1B and 1C.

In accordance with various embodiments of the present invention, each of the one or more NLP resources 122(1), 122(2) . . . 122(n) is a logically separate resource and works independently from another. In accordance with various embodiments of the present invention, each of the NLP resource 122(1), 122(2) . . . 122(n) hosted by the Natural Language processing engine 110 is individually configurable to perform natural language processing of queries associated with respective one or more domains and emulate human-like responses associated with the respective one or more domains based on the natural language processing. In an exemplary embodiment of the present invention, the one or more domains are corresponding to the one or more domains serviced by the enterprise application 106. Examples of domain may include, but are not limited to, banking services, payment services, shopping and ecommerce service, health care services etc.

In accordance with various embodiments of the present invention as shown in FIG. 1B, each of the one or more NLP resources 122(1), 122(2) . . . 122(n) comprises one or more logically independent Artificial Intelligence (AI)-based units hereinafter referred to as pods (122n (1), 122n (2) . . . 122n (N)), a pod selection unit 122na, and a pod database 122nb. The various units of each of the NLP resources 122(1), 122(2) . . . 122(n) are operated via the processor 114 specifically programmed to execute instructions stored in the memory 112 for executing respective functionalities of the multiple units (122na; 122nb; and 122n(1), 122n(2), 122n(3) . . . 122n(N)) in accordance with various embodiments of the present invention.

In accordance with various embodiments of the present invention, each of the one or more pods (122n(1), 122n(2) . . . 122n(N)) are individually configurable to perform natural language processing of queries and emulate human-like responses associated with respective one or more subdomains associated with the one or more domains of the corresponding NLP resource 122(1), 122(2) . . . 122(n). Each of the one or more pods (122n(1), 122n(2) . . . 122n(N)) together enable the corresponding NLP resource 122(1), 122(2) . . . 122(n) to perform natural language processing of queries and emulate human-like responses associated with the entire domain. For instance: if the domain of the NLP resource is banking, then the individual one or more pods (122n(1), 122n(2) . . . 122n(N)) are modelled to perform natural language processing and emulate human-like responses associated with sub-domains of the banking domain, such as, but not limited to, retail banking, corporate banking, NRI banking, credit cards, loans, branch and ATM finder, and products. In an exemplary embodiment of the present invention, the one or more pods (122n(1), 122n(2) . . . 122n(N)) are modelled to perform natural language processing and emulate human-like responses associated with respective sub-domains based on respective utterances-intent dataset of said sub-domains. In an exemplary embodiment of the present invention, the one or more pods (122n(1), 122n(2) . . . 122n(N)) are modelled using one or more machine learning techniques such as supervised machine learning or unsupervised machine learning based on respective utterances-intent dataset. For instance: if the sub-domain is retail banking, then the dataset comprises multiple utterances that can train the pod to identify the intent of queries associated with retail banking. For example in retail banking dataset, there may be utterances such as “I want to make a payment”, “I am looking to pay Bob”, “I want to pay my rent” etc. associated with an intent such as “Make a Payment”. As a result, any of the user queries with similar utterances can trigger a pod trained with the exemplified dataset to provide an appropriate response of making payment on successfully deriving the intent to “Make a Payment” from the query utterance. It is to be understood that modelling of the one or more pods (122n(1), 122n(2) . . . 122n(N)) for a sub-domain is further dependent on modelling of AI-based micro-units within the respective pods, as explained later in specification. In accordance with various embodiments of the present invention, each of the one or more pods (122n(1), 122n(2) . . . 122n(N)) are configured to support one or more Natural Language Processing classes including, but not limited to, Conversational class, question and answer(Q and A), sematic search, sentiment analysis, and text summarization to work together to service received queries. Each of the one or more pods (122n (1), 122n (2) . . . 122n (N)) are individually scalable, leading to flexibility in scaling and descaling of the respective NLP resource 122(1), 122(2) . . . 122(n).

In an embodiment of the present invention, each of the one or more pods (122n(1), 122n(2) . . . 122n(N)) comprises individual input/output addresses, a pod broadcast address and a pod multicast address to receive the query and output a response. In an embodiment of the present invention, the one or more pods 122n(1), 122n(2) . . . 122n(N) may be logically connected via a single pod broadcast address and a single pod multicast address for simultaneously receiving broadcasted and multicast queries. In an embodiment of the present invention, the one or more pods (122n(1), 122n(2) . . . 122n(N)) are logically connected to the pod selection unit 122na using adapter patterns. The one or more pods (122n(1), 122n(2) . . . 122n(N)) are configured to receive queries via the pod selection unit 122na as explained later in the specification. In accordance with various embodiments of the present invention, each of the one or more pods (122n(1), 122n (2) . . . 122n(N)) are configured to receive the natural language queries, perform natural language processing of the queries, and provide a response to the queries via artificial intelligence based micro-units as explained later in the specification with reference to FIG. 1C.

In accordance with an embodiment of the present invention, the pod selection unit 122na of the identified NLP resource is configured to receive the natural language query from the routing unit 118. Further, the pod selection unit 122na is configured to route the queries for Natural Language processing to the one or more pods (122n(1), 122n(2) . . . 122n(N)) based on the information stored in the pod database 122nb using at least one of: a select technique, a broadcast and select technique; and a search, multicast and select technique along with a set of predefined policies. The pod database 122nb as explained in detail later in the specification comprises at least a list of serving pods with pod ratings, user-session details, training utterances-intent dataset for each pod, user feedback and user-attributes.

In operation, the pod selection unit 122na is configured to assess if the query received via the computing device 102 is from a new user or an existing user by analyzing user-session details in the pod database 122nb. The pod selection unit 122na is configured to select a pod 122n(N) which had previously serviced the user using the information in the pod database 122nb based on the assessment that the query is from an existing user. The pod selection unit 122na is configured to analyze the scope of response received from the selected pod 122n(N) using at least the training utterance-intent information in the pod database 122nb. Further, the pod selection unit 122na is configured to continue the session with the same pod 122n(N) unless an out of scope response is received.

In an embodiment of the present invention, the pod selection unit 122na is configured to trigger a pod selection process using at least one of: a broadcast and select technique; and a search, multicast and select technique based on the assessment that the query is from a new user or an out of scope response is received. In an embodiment of the present invention, the pod selection unit 122na is configured to choose between the broadcast and select technique; and a search, multicast and select technique based on an assessment of the number of pods.

In an embodiment of the present invention, the pod selection unit 122na is configured to perform pod selection using the broadcast and select technique if the number of pods associated with the identified NLP resource are less than a predefined number. In an exemplary embodiment of the present invention, the predefined number is 25. In an embodiment of the present invention, the pod selection via broadcast and select technique includes publishing the query with expected response time to each of the one or more pods (122n(1), 122n(2) . . . 122n(N)). Further, the scope of responses received within the expected response time from the one or more pods (122n(1), 122n(2) . . . 122n(N)) are assessed using at least the training utterance-intent information in the pod database 122nb. In operation, if only one response is received within the expected response time, the scope of one response is assessed by the pod selection unit 122na, and the response is provided to the user. Further, if multiple responses are received from the one or more pods (122n(1), 122n(2) . . . 122n(N)) within the expected response time the scope of one or more responses may be assessed, and the most appropriate in scope response is selected using a set of predefined policies. In an exemplary embodiment of the present invention, the set of predefined policies may include one or more disambiguation policies, such as “Feeling Lucky” which chooses first non-out of scope response from any pod out of the one or more pods of the identified NLP resource that responded first without waiting for a response from other pods, “Most Suitable” which chooses a non-out of scope response from a pod out of the one or more pods having minimum centroid of vector distance of training utterance from the incoming query utterance, “Most Reputed” which chooses a non-out of scope response from a pod out of the one or more pods of the identified NLP resource having highest rating. Furthermore, the pod selection unit 122na provides the most appropriate response to the user. Yet further, all further queries are subsequently transmitted to the pod which is providing the most suitable response until an out of scope response is received. In an embodiment of the present invention, the pod selection unit 122na is configured to assess the scope of responses throughout the user session, and is configured to maintain the scope of responses by routing the query to the appropriate pods 122n(1), 122n(2) . . . 122n(N) until all the pods provide an out of scope response. Further, in an embodiment of the present invention, the pod selection unit 122na is configured to maintain context of the responses received from the one or more pods 122n(1), 122n(2) . . . 122n(N) throughout the user-session. The term “context” as already described above in the specification refers to a collection of “intents” and “entities” derived during a user-session. In an exemplary embodiment of the present invention, the pod selection unit 122na is configured to maintain context of responses using a global user context service. In an embodiment of the present invention, the pod selection unit 122na is configured to transmit an out of scope response to the user if the responses received from each of the one or more pods (122n(1), 122n(2) . . . 122n(N)) are out of scope.

In an embodiment of the present invention, the pod selection unit 122na is configured to perform pod selection using the search, multicast and select technique if the number of pods associated with the NLP resource identified for responding to the query are more than a predefined number. In an embodiment of the present invention, the search, multicast and select technique, includes transforming the user query to a vector using sentence embedding. Further, a k-nearest neighbors (Knn) search of user query is performed in the pod database 122nb, where a centroid of training utterances of each pod are stored. Furthermore, a preset number pods i.e. top N pods that are trained with utterances semantically closest to the query are selected based on the Knn search. Yet further, the query with expected response time is published to the top N pods out of the one or more pods (122n(1), 122n(2) . . . 122n(N)). Further, the scope of responses received within the expected response time from the top N pods out of the one or more pods (122n(1), 122n(2) . . . 122n(N)) is assessed using at least the training utterance-intent information in the pod database. In operation, if only one response is received within the expected response time, the scope of one response is assessed by the pod selection unit 122na, and the response is provided to the user. Further, if multiple responses are received from the top N pods within the expected response time, the scope of one or more responses may be assessed, and the most appropriate in scope response is selected using a set of predefined policies. Furthermore, the most appropriate response is provided to the user. Yet further, all further queries are subsequently transmitted to the pod providing the most suitable response until an out of scope response is received. In an embodiment of the present invention, the pod selection unit 122na is configured to transmit an out of scope response to the user if the responses received from each of the one or more pods (122n(1), 122n(2) . . . 122n(N)) are out of scope. It is to be understood that all queries broadcasted/multicasted to the pods are processed via AI-based micro-units within the respective pods and the responses are generated by the AI-based micro units. Further the micro-unit selection within the pods as explained later in the specification is similar to the pod selection process.

In an embodiment of the present invention, the pod selection unit 122na is configured to maintain a serving store, a session store, a user store, and a user-specific routing table, a QueryCache, and a feedback store in the pod database 122nb. In an embodiment of the present invention, the serving store (not shown) in the database 122nb comprises a list of available pods (122n(1), 122n(2) . . . 122n(N)) which can be directly reached by the pod selection unit 122na. In an embodiment of the present invention, the list of available pods is maintained based on a plurality of attributes including, but not limited to, pod identifier, pod name, pod version, pod type, domain, subdomain supported, utterances(in particular centroid of vectors of utterances) used to train the pod, Connection protocol, private input/output address (adapter request and response topics), status (online or offline), scope (internal or external), class (conversational, FAQ, question and answer system, semantic search, knowledge graph, NA), pod rating (beginner, intermediate, professional, expert), channels supported (web, mobile interface, Interactive Voice Response (IVR), WhatsApp, Apple Business Chat (ABC) and Facebook Messenger (FBM)), and average response time. In an embodiment of the present invention, the list of available pods is dynamically updated and stored in the database 122nb. Further, any new utterances used for training the pods are also updated in the database 122nb. In an embodiment of the present invention, the pod Ratings and/or the training utterances enable the pod selection unit 122na to select the most relevant pod when multiple pods generate responses to a user query during the broadcast and select technique.

In an embodiment of the present invention, the session store (not shown) in the database 122nb is configured to store details associated with previous and existing user sessions. The session store is further configured to store context as provided by serving pods in their responses as the conversation between the client computing device 102 and the NLP system 104 progresses. The pod selection unit 122na maintains session store to create and update user sessions. In an embodiment of the present invention, every user session has a log which specifies the pod handling the existing conversation and the pods which have handled the previous conversations. The session store enables the pod selection unit 122na to forward all the incoming queries associated with a user to the pod currently serving the user unless an out of scope response is generated by said serving pod.

In an embodiment of the present invention, the user store (not shown) comprised by the database 122nb is configured to maintain user profiles of various users communicating through the computing device 102. In an embodiment of the present invention, the user profiles are maintained based on predefined user-attributes. In an exemplary embodiment of the present invention, the predefined user-attributes may include, but are not limited to, demographics, location, and user preferences. Examples of demographics may include, but are not limited to, user ethnicity, age/generation, gender, income, marital status, and education. It is to the noted that the communication with the system 104 is not limited to a single computing device 102, one or more users may be interfacing via the same or individual computing devices 102. In an embodiment of the present invention, the user profiles may be retrieved from an external Customer relationship management (CRM) system. The user store enables the identification of a user across different channels such as WhatsApp, web, mobile interface etc. to provide an Omni Channel experience, where a user can start a conversation in one channel and continue the same in a different channel. Further, the user-attributes in the user store enables the pod selection unit 122na to choose a suitable pod out of the one or more pods 122n(1), 122n(2) . . . 122n(N).

In an embodiment of the present invention, the user-specific routing table in the database 122nb is configured to store recommended routing options for a user based on user's interactions and transactions across the domain.

In an embodiment of the present invention, the QueryCache (not shown) in the database 122nb comprises logs of all incoming queries and the responses provided by the one or more pods to the incoming queries.

In an embodiment of the present invention, the feedback store (not shown) comprised by the database 122nb is configured to store logs of feedback received from users through various surveys that are run by the system 104. The feedback along with other predefined attributes enables the pod selection unit 122na to update pod ratings in the serving store.

Referring to FIG. 1C a block diagram of an artificial intelligence based unit referred to as a pod is illustrated in accordance with an embodiment of the present invention. In an embodiment of the present invention as shown in FIG. 1C, each of the one or more pods(122n(1), 122n(2) . . . 122n (N)) comprise logically independent one or more AI-based micro-units hereinafter referred to as Micro-pods (122n(N)1, 122n(N)2, 122n(N)3 . . . 122n(N)n); a Micro-pod coordinator 122n(N)a; and a Micro-pod database 122n(N)b. The various micro-units of each of the one or more pods(122n(1), 122n (2) . . . 122n (N)) are operated via the processor 114 specifically programmed to execute instructions stored in the memory 112 for executing respective functionalities of the multiple micro-units 122n(N)a, 122n(N)b, and (122n(N)1, 122n(N)2, 122n(N)3 . . . 122n(N)n), in accordance with various embodiments of the present invention.

In accordance with various embodiments of the present invention each of the one or more micro-pods 122n(N)1, 122n(N)2, 122n(N)3 . . . 122n(N)n are configurable to perform natural language processing of queries and emulate human-like responses associated with respective one or more topics associated with the one or more subdomains of the corresponding pod. In an embodiment of the present invention, each of the one or more micro-pods 122n(N)1, 122n(N)2, 122n(N)3 . . . 122n(N)n are modelled to perform natural language processing and emulate human-like responses associated with respective high level topics of the sub-domain of the corresponding pod, and together emulate human-like responses associated with the entire sub-domain. For instance: if the domain of the NLP resource is banking, and the sub-domain of an associated pod is retail banking, then the individual one or more micro-pods 122n(N)1, 122n(N)2, 122n(N)3 . . . 122n(N)n are modelled to process queries and emulate responses associated with high level topics of the retail banking sub-domain, such as, but not limited to, Balance, Payments, Direct Debit, Payment Status, International Payments, Payments FAQ, and Payment Terms and Condition. In an exemplary embodiment of the present invention, the one or more micro-pods 122n(N)1, 122n(N)2, 122n(N)3 . . . 122n(N)n are modelled to perform natural language processing of queries and emulate human-like responses associated with respective high level topics based on respective utterances-intent dataset of said topics. In an exemplary embodiment of the present invention, the one or more micro-pods 122n(N)1, 122n(N)2, 122n(N)3 . . . 122n(N)n are modelled using one or more machine learning techniques such as supervised machine learning or unsupervised machine learning based on respective utterances-intent dataset. For instance, if the topic is “payment”, then the dataset comprises multiple utterances that can train the micro-pod to identify the intent of queries associated with payment topic. In an exemplary topic dataset, there may be utterances such as “I want to make a payment”, “I am looking to pay Bob”, “I want to pay my rent” etc. associated with an intent such as “Make a Payment”. As a result, any of the user queries with similar utterances can trigger a micro-pod trained with the exemplified dataset to generate an appropriate response of making payment, after successfully deriving the intent to “Make a Payment” from the query utterance. It can be understood that the modelling of the one or more micro-pods 122n(N)1, 122n(N)2, 122n(N)3 . . . 122n(N)n associated with a pod to perform natural language processing and emulate human-like responses associated with respective high level topics enables the modelling of the entire pod to perform natural language processing and emulate human-like responses associated with the sub-domain of the pod. Further, each of the one or more micro-pods 122n(N)1, 122n (N)2, 122n(N)3 . . . 122n(N)n are individually scalable, leading to flexibility in scaling and descaling of the corresponding pods (122n(1), 122n (2) . . . 122n (N)).

In accordance with various embodiments of the present invention, each of the one or more micro-pods 122n(N)1, 122n(N)2, 122n(N)3 . . . 122n(N)n are configured to perform Natural Language processing of the received query to understand the user's intent, extract entities from user's query, perform validations, manage the dialog, execute an action and provide a response back to the user. The one or more micro-pods 122n(N)1, 122n (N)2, 122n(N)3 . . . 122n(N)n enable focused execution of query in the corresponding NLP resource 122(n).

In accordance with various embodiments of the present invention, the one or more micro-pods 122n(N)1, 122n(N)2, 122n(N)3 . . . 122n(N)n associated with a pod can be modeled to support same or different classes of natural language processing. In an exemplary embodiment of the present invention, the various classes of natural language processing include conversational class, Frequently Asked Question (FAQ), question and answer, semantic search, and knowledge graph. In a preferred embodiment of the present invention, the one or more micro-pods 122n(N)1, 122n (N)2, 122n(N)3 . . . 122n(N)n are modeled to support a combination of different classes as exemplified above. For instance for a pod associated with retail banking sub-domain, the corresponding micro-pods can be Bill Payments (Goal Oriented class), Direct Debit, Payment Status, International Payments, Payments FAQ (FAQ class), and Payment Terms and Condition (Semantic Search class).

In an embodiment of the present invention, each of the one or more micro-pods 122n(N)1, 122n(N)2, 122n(N)3 . . . 122n(N)n have a broadcast address, a multicast address and individual input/output address. In an embodiment of the present invention, the broadcast address is configured for receiving broadcasted request topics and publishing a response to the broadcasted request topics. The multicast address is configured to receiving multicast topics and publishing the response to the multicast topics. The input/output addresses are configured to receive individual request topics and publish a response to the individual request topics. In an embodiment of the present invention, each of the one or more micro-pods 122n(N)1, 122n(N)2, 122n(N)3 . . . 122n(N)n may be logically connected via a single broadcast address and a single multicast address for simultaneously receiving broadcasted and multicast request topics.

In accordance with various embodiments of the present invention, the Micro-pod database 122n(N)b is configured to store and maintain a list of available micro-pods 122n(N)1, 122n(N)2, 122n(N)3 . . . 122n(N)n that can be directly reached by the Micro-pod coordinator 122n(N)a. In an embodiment of the present invention, the list of available micro-pods 122n(N)1, 122n(N)2, 122n(N)3 . . . 122n(N)n is maintained based on a plurality of micro-pod attributes including, but not limited to, micro-pod Identifier, micro-pod Name, micro-pod Version, domain, subdomain and high level topic supported, utterance-intent dataset (in particular centroid of vector of utterances) used to train the micro-pod, connection protocol, input/output address, status (online or offline), scope (internal or external), class (conversational, FAQ, question and answer, semantic search, knowledge graph, NA), micro-pod rating (beginner, intermediate, professional, expert), channels supported, and average response time. The list of available micro-pods is dynamically updated and stored in the micro-pod database 122n(N)b via the micro-pod coordinator 122n(N)a. In an embodiment of the present invention, the micro-pod database 122n(N)b is configured to maintain a log of all incoming queries and the response provided by the one or more micro-pods to the query.

In an embodiment of the present invention, the one or more micro-pods 122n(N)1, 122n(N)2, 122n(N)3 . . . 122n(N)n are logically coupled with the Micro-pod coordinator 122n(N) using adapter patterns. In an embodiment of the present invention, the Micro-pod coordinator 122n(N)a is configured to perform micro-pod selection and routing for servicing a query at the pod level using the Micro-pod database 122n(N)b. In an embodiment of the present invention the Micro-pod coordinator 122n(N)a is configured to receive the natural language query. In operation, the query routed to the identified NLP resource 122(n) is routed to a single pod 122n(N) or one or more pods 122n(1), 122n(2) . . . 122n(N) via the pod selection unit 122na using at least one of: a select; a broadcast and select; a search, multicast and select technique. Further, the Micro-pod coordinator 122n(N)a of the respective one or more pods 122n(1), 122n(2) . . . 122n(N) is configured to receive the query and route the query to the one or more micro-pods 122n(N)1, 122n(N)2, 122n(N)3 . . . 122n(N)n using at least one of: select; broadcast and select; search, multicast and select techniques.

In accordance with various embodiments of the present invention, the response(s) from the one or more micro-pods 122n(N)1, 122n (N)2, 122n(N)3 . . . 122n(N)n are received by the Micro-pod coordinator 122n(N)a. The Micro-pod coordinator 122n(N) of respective pods 122n(1), 122n(2) . . . 122n(N) transmits the received responses to the pod selection unit 122na for final analysis. The pod selection unit 122na selects the most appropriate response based on an analysis performed using the set of predefined policies. As already exemplified above the set of predefined policies may include one or more disambiguation policies, such as “Feeling Lucky” which chooses the first non-out of scope response from any micro-pod that responded first without waiting for a response from other micro-pods, “Most Suitable” which chooses a non-out of scope response from a micro-pod having minimum centroid of vector distance of training utterance from customer query utterance, “Most Reputed” which chooses a non-out of scope response from the micro-pod having highest rating. Subsequently, the most appropriate response is transmitted to the client computing device 102. Subsequent queries from the same user are efficiently directed to the same pod 122n(N) and the same Micro-pod until an out of scope response is received. Post receiving an out of scope response a Micro-pod selection process is performed at the pod-level using broadcast and select technique; and search, multicast and select technique. Further, the pod selection process is re-initiated using the broadcast and select technique; and search, multicast and select technique if the micro-pods 122n(N)1, 122n(N)2, 122n(N)3 . . . 122n(N)n continue to provide an out of scope response. Further, the query is transmitted to a human if the re-selected pods continue to provide an out of scope response.

In accordance with various embodiments of the present invention, the resource modelling unit 124 is configured to receive admin requests for modelling the one or more NLP resources 122(1), 122(2) . . . 122(n). In particular, the resource modelling unit 124 is configured to receive admin requests for modelling individual pods 122n(1), 122n(2) . . . 122n(N) and micro-pods 122n(N)1, 122n(N)2, 122n(N)3 . . . 122n(N)n of respective NLP resources 122(1), 122(2) . . . 122(n). In various embodiments of the present invention, the resource modelling unit 124 is configured with multiple modelling tools to add, modify or remove individual pods 122n(1), 122n(2) . . . 122n(N) and micro-pods 122n(N)1, 122n (N)2, 122n(N)3 . . . 122n(N)n. In an embodiment of the present invention, the resource modelling unit 124 is configured to register each of the one or more NLP resources 122(1), 122(2) . . . 122(n) with the resource database 120. In an exemplary embodiment of the present invention, the registration of the respective one or more NLP resources 122(1), 122(2) . . . 122(n) with the resource database 120 comprises loading of a resource configuration file for each of the one or more NLP resources 122(1), 122(2) . . . 122(n). The resource configuration file includes details, such as, but not limited to, connectivity pattern (message base or API based) and connection details (API endpoint or Topic Address) for each of the one or more NLP resources 122(1), 122(2) . . . 122(n).

Advantageously, the system of the present invention, provides flexibility in scaling and descaling of the one or more domains both in depth and breadth. Further, the system of the present invention, enables dynamic addition or removal of individual AI-based units and Micro-units at run time without impacting the overall system. Furthermore, the system of the present invention, reduces response time and enhances precision in processing of the natural language queries as the queries can be directly serviced by appropriate AI-based units and AI-based Micro-units.

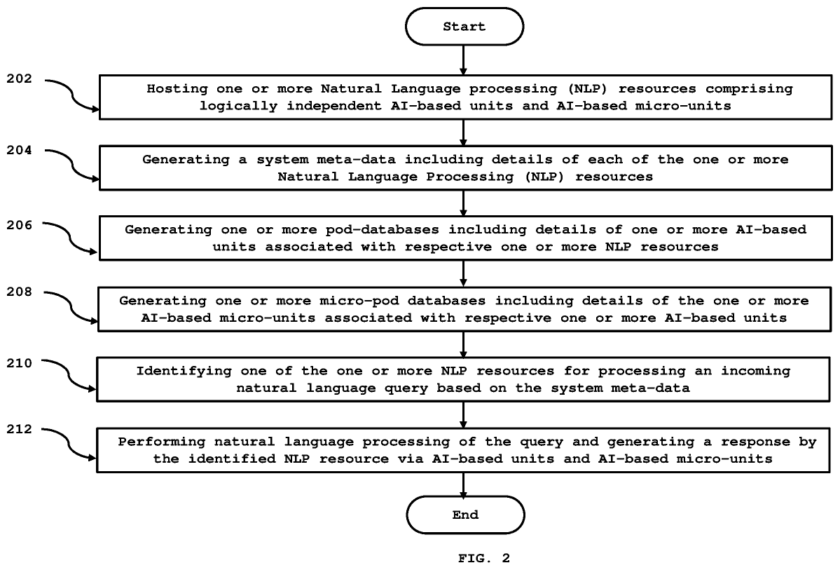

Referring to FIG. 2 a flowchart of the method for providing natural language processing of queries associated with various domains is shown, in accordance with various embodiments of the present invention.

At step 202, one or more Natural Language Processing (NLP) resources are hosted. In an embodiment of the present invention, the hosted one or more NLP resources (122(1), 122(2) . . . 122(n) of FIG. 1) are individually configurable to perform natural language processing of queries associated with respective one or more domains and emulate human-like responses associated with the respective one or more domains based on the natural language processing. Examples of domain may include, but are not limited to, banking services, payment services, shopping and ecommerce service, health care services etc. In an exemplary embodiment of the present invention, the one or more domains are corresponding to the one or more domains serviced by an enterprise application (106 of FIG. 1). In accordance with various embodiments of the present invention, each of the one or more NLP resources are logically separate resources and work independently from one another. Further, the one or more NLP resources are configured to perform natural language processing of the natural language query and provide appropriate responses to the query via Artificial Intelligence (AI)-based units and AI-based micro units.

In accordance with various embodiments of the present invention, each of the one or more NLP resources comprises one or more logically independent Artificial Intelligence (AI)-based units, hereinafter, referred to as pods. Each of the one or more pods a are individually configurable to perform natural language processing of queries and emulate human-like responses associated with respective one or more subdomains associated with the one or more domains of the corresponding NLP resource. Each of the one or more pods together enable the corresponding NLP resource to perform natural language processing of queries and emulate human-like responses associated with the entire domain. For instance: if the domain of the NLP resource is banking, then the individual one or more pods are modelled to perform natural language processing and emulate human-like responses associated with sub-domains of the banking domain, such as, but not limited to, retail banking, corporate banking, NRI banking, credit cards, loans, branch and ATM finder, and products. In an exemplary embodiment of the present invention, the one or more pods are modelled to perform natural language processing and emulate human-like responses associated with respective sub-domains based on respective utterances-intent dataset of said sub-domains. In an exemplary embodiment of the present invention, the one or more pods are modelled using one or more machine learning techniques, such as, but not limited to, supervised machine learning or unsupervised machine learning based on respective utterances-intent dataset. For instance: if the sub-domain is retail banking, then the dataset comprises multiple utterances that can train the pod to identify the intent of queries associated with retail banking. For example in retail banking dataset, there may be utterances such as “I want to make a payment”, “I am looking to pay Bob”, “I want to pay my rent” etc. associated with an intent such as “Make a Payment”. As a result, any of the user queries with similar utterances can trigger a pod trained with the exemplified dataset to provide an appropriate response of making payment on successfully deriving the intent to “Make a Payment” from the query utterance.

In accordance with various embodiments of the present invention, each of the one or more pods are individually scalable, leading to flexibility in scaling and descaling of the corresponding NLP resource. Further, each of the one or more pods are configured to support one or more Natural Language Processing classes including, but not limited to, Conversational class, question and answer, sematic search, sentiment analysis, and text summarization to work together to service received queries.

In an embodiment of the present invention, each of the one or more pods comprise individual input/output addresses, a pod broadcast address and a pod multicast address to receive the query and output a response. In an embodiment of the present invention, the one or more pods may be logically connected via a single pod broadcast address and a single pod multicast address for simultaneously receiving broadcasted and multicast queries. In an embodiment of the present invention, the one or more pods are logically connected to the corresponding NLP resource using adapter patterns. The one or more pods are configured to receive natural language queries, perform natural language processing of the queries, and provide a response to the queries via artificial intelligence based micro-units.

In various embodiments of the present invention each of the one or more pods are modelled by further modelling logically independent one or more AI-based micro-units hereinafter referred to as Micro-pods comprised by each of the one or more pods. In accordance with various embodiments of the present invention, each of the one or more micro-pods are configurable to perform natural language processing of queries and emulate human-like responses associated with respective one or more topics associated with the one or more subdomains of the corresponding pod. In an embodiment of the present invention, each of the one or more micro-pods are modelled to perform natural language processing and emulate human-like responses associated with respective high level topics of the sub-domain of the corresponding pod, and together emulate human-like responses associated with the entire sub-domain. For instance: if the domain of the NLP resource is banking, and the sub-domain of an associated pod is retail banking, then the individual one or more micro-pods are modelled to process queries and emulate responses associated with high level topics of the retail banking sub-domain, such as, but not limited to, Balance, Payments, Direct Debit, Payment Status, International Payments, Payments FAQ, and Payment Terms and Condition. In an exemplary embodiment of the present invention, the one or more micro-pods are modelled to perform natural language processing of queries and emulate human-like responses associated with respective high level topics based on respective utterances-intent dataset of said topics. In an exemplary embodiment of the present invention, the one or more micro-pods are modelled using one or more machine learning techniques, such as supervised machine learning or unsupervised machine learning based on respective utterances-intent dataset. For instance, if the topic is “payment”, then the dataset comprises multiple utterances that can train the micro-pod to identify the intent of queries associated with payment topic. In an exemplary topic dataset, there may be utterances such as “I want to make a payment”, “I am looking to pay Bob”, “I want to pay my rent” etc. associated with an intent, such as “Make a Payment”. As a result, any of the user queries with similar utterances can trigger a micro-pod trained with the exemplified dataset to generate an appropriate response of making payment, after successfully deriving the intent to “Make a Payment” from the query utterance. Each of the one or more micro-pods are individually scalable, leading to flexibility in scaling and descaling of the corresponding pods.

In various embodiment of the present invention, each of the one or more micro-pods are configured to perform Natural Language processing of the received query to understand the user's intent, extract entities from user's query, perform validations, manage the dialog, execute an action and provide a response back to the user. The one or more micro-pods enable focused execution of query in the corresponding NLP resource.

In various embodiments of the present invention, the one or more micro-pods associated with a pod can be modelled to support same or different classes of natural language processing. In an exemplary embodiment of the present invention, the various classes of natural language processing include Conversational class, Frequently Asked Question (FAQ), Question and Answer, Semantic Search, and Knowledge Graph. In a preferred embodiment of the present invention, the one or more micro-pods are modeled to support a combination of different classes as exemplified above. For instance, in a pod associated with retail banking sub-domain, the corresponding micro-pods can be Bill Payments (Goal Oriented class), Direct Debit, Payment Status, International Payments, Payments FAQ (FAQ class), and Payment Terms and Condition (Semantic Search class).

In an embodiment of the present invention, each of the one or more micro-pods have a broadcast address, a multicast address and individual input/output address. In an embodiment of the present invention, the broadcast address is configured for receiving broadcasted request topics and publishing a response to the broadcasted request topics. The multicast address is configured to receiving multicast topics and publishing the response to the multicast topics. The input/output addresses are configured to receive individual request topics and publish a response to the individual request topics. In an embodiment of the present invention, each of the one or more micro-pods may be logically connected via a single broadcast address and a single multicast address for simultaneously receiving broadcasted and multicast request topics. In an embodiment of the present invention, the one or more micro-pods are logically coupled with the corresponding pods using adapter patterns.

At step 204, a system meta-data including details of each of the one or more Natural Language Processing (NLP) resources is generated. In an embodiment of the present invention, the system meta-data comprises details associated with each of the one or more NLP resources. In an embodiment of the present invention, the details in the system meta-data includes, but is not limited to, names of each of the one or more NLP resources, domain of each of the one or more NLP resources, resource identifiers of each of the one or more NLP resources, identifiers of channels supported (web, mobile interface, Interactive Voice Response (IVR), WhatsApp, Apple Business Chat (ABC) and Facebook Messenger (FBM)), serving matrix, resilience rating for each of the one or more NLP resources, data classification ratings of each of the one or more NLP resources.

At step 206, one or more pod-databases including details of the one or more AI-based units (pods) associated with respective one or more NLP resources are generated. In an embodiment of the present invention, each of the one or more pod-databases of respective NLP resources are configured to maintain a serving store, a session store, a user store, a user-specific routing table, a QueryCache, and a feedback store. In an embodiment of the present invention, the serving store comprises a list of available pods which can be directly reached for processing the query. In an embodiment of the present invention, the list of available pods is maintained based on a plurality of attributes including, but not limited to, pod identifier, pod name, pod version, pod type, domain, subdomain supported, utterances(in particular centroid of vectors of utterances) used to train the pod, Connection protocol, private input/output address (adapter request and response topics), status (online or offline), scope (internal or external), class (conversational, FAQ, question and answer system, semantic search, knowledge graph, NA), pod rating (beginner, intermediate, professional, expert), channels supported (web, mobile interface, Interactive Voice Response (IVR), WhatsApp, Apple Business Chat (ABC) and Facebook Messenger (FBM)), and average response time. The list of available pods is dynamically updated and stored. Further, any new utterances used for training the pods are also updated. In an embodiment of the present invention, the pod ratings enable selection of the most relevant pod out of the multiple pods.

In an embodiment of the present invention, the session store comprises details associated with previous and existing user sessions, and context as provided by serving pods in their responses during the conversation between a user of the client computing device 102 of FIG. 1 and the NLP resource. In an embodiment of the present invention, every user session has a log which specifies the pod serving the existing queries in a conversation and the pods which have served the previous queries in the conversations. The session store enables forwarding of all the incoming queries associated with a user to the pod currently serving the user unless an out of scope response is generated by said serving pod.

In an embodiment of the present invention, the user store maintains user profiles of various users communicating through the computing device (102 of FIG. 1, FIG. 2). In an embodiment of the present invention, the user profiles are maintained based on predefined user-attributes. In an exemplary embodiment of the present invention, the predefined user-attributes may include, but are not limited to, demographics, location, and user preferences. Examples of demographics may include, but are not limited to, user ethnicity, age/generation, gender, income, marital status, and education. In an embodiment of the present invention, the user profiles may be retrieved from an external Customer relationship management (CRM) system. The user store enables the identification of a user across different channels such as WhatsApp, web, mobile interface etc. to provide an Omni Channel experience, where a user can start a conversation in one channel and continue the same in a different channel.

In an embodiment of the present invention, the user-specific routing table comprises recommended routing options for a user based on user's interactions and transactions across the domain. In an embodiment of the present invention, the QueryCache comprises logs of all incoming queries and the response provided by the one or more pods to the incoming queries.

In an embodiment of the present invention, the feedback store comprises logs of feedback received from users through various surveys run at the end of a user-session. The feedback along with other predefined attributes enable upgradation of pod ratings in the serving store.

At step 208, one or more micro-pod databases including details of the one or more AI-based micro-units(micro-pods) associated with respective one or more AI-based units(pods) are generated. In various embodiment of the present invention, the Micro-pod database comprises a list of available micro-pods that can be directly reached for processing the natural language query and generating a response, log of all incoming queries, and the response provided to the queries. In an embodiment of the present invention, the list of available micro-pods is maintained based on a plurality of micro-pod attributes including, but not limited to, micro-pod Identifier, micro-pod Name, micro-pod Version, sub-domain supported, High-level topic dataset (in particular, centroid of vectors of utterances) used to train the micro-pod, connection protocol, input/output address, status (online or offline), scope (internal or external), class (conversational, FAQ, question and answer, semantic search, knowledge graph, NA), micro-pod rating (beginner, intermediate, professional, expert), channels supported, and average response time. The list of available pods is dynamically updated and stored.

At step 210, one of the one or more NLP resources is identified for processing a natural language query received from the user based on the system meta-data. In operation, the natural language query is received via a computing device (102 of FIG. 1). In an embodiment of the present invention, one of the one or more NLP Resources is identified based on a mapping between the query domain and the domain of the NLP resource using the system meta-data. In another embodiment of the present invention, one of the one or more NLP resources is identified based on a mapping between the resource identifier embedded in the received query and the resource identifier associated with the one or more NLP resources in the system meta-data. In an exemplary embodiment of the present invention, a software module (not shown) installable on the client computing device 102 comprises resource identifiers of the one or more NLP resources. Further, the software module enables embedding of the resource identifier with the query.

At step 212, natural language processing of the query is performed and a response is generated by the identified NLP resource. In an embodiment of the present invention, the processing of the query and generation of response is performed via the one or more AI-based units and one or more AI-based micro-units selected using at least one of: details stored in the one or more pod-databases and micro-pod databases, a broadcast and select technique, and a search, multicast and select technique along with a predefined set of policies.

In operation, the received query is assessed to determine if the query is from a new user or an existing user by analyzing user-session details in the pod-database of the identified NLP resource. A pod which had previously serviced the user is selected using the pod database on determination that the query is from an existing user. Further, the scope of response received from the selected pod is assessed using at least the training utterance-intent information in the pod database. All incoming queries from the user are routed to the same pod unless an out of scope response is received. It is to be understood that the response generated by the selected pod is in turn generated by the micro-pods associated with said pod.

In an embodiment of the present invention, a pod selection process is triggered using at least one of: a broadcast and select technique; and a search, multicast and select technique if the query is from a new user or an out of scope response is received. Further, an assessment of the number of pods within the NLP resource is performed. In an embodiment of the present invention, pod selection using the broadcast and select technique is performed if the number of pods associated with the identified NLP resource are less than a predefined number. In an exemplary embodiment of the present invention, the predefined number is 25. In an embodiment of the present invention, the pod selection using search, multicast and select technique is performed if the number of pods associated with the identified NLP resource are more than the predefined number 25.

In an embodiment of the present invention, the pod selection via broadcast and select technique includes publishing the query with expected response time to each of the one or more pods of the identified NLP resource. Further, the scope of responses received within the expected response time from the one or more pods are assessed using at least the training utterance-intent information in the pod database. In operation, if only one response is received within the expected response time, the scope of one response is assessed, and the response is provided to the user. Further, if multiple responses are received from the one or more pods within the expected response time, the most appropriate in scope response is selected using a set of predefined policies. In an exemplary embodiment of the present invention, the set of predefined policies may include one or more disambiguation policies, such as “Feeling Lucky” which chooses first non-out of scope response from any pod out of the one or more pods of the identified NLP resource that responded first without waiting for a response from other pods, “Most Suitable” which chooses a non-out of scope response from a pod out of the one or more pods having minimum centroid of vector distance of training utterance from the incoming query utterance, “Most Reputed” which chooses a non-out of scope response from a pod out of the one or more pods of the identified NLP resource having highest rating. Furthermore, the most appropriate response is provided to the user. Yet further, all further queries are subsequently transmitted to the pod providing the most suitable response, until an out of scope response is received. In an embodiment of the present invention, the pod selection using the broadcast and select technique is re-initiated if the received response is out of scope. Further, an out of scope response is transmitted to the user if all the responses received after re-initiation of pod selection are out of scope. Furthermore, a human chat session is initiated by transferring the query to a technical group.

In an embodiment of the present invention, the search, multicast and select technique, includes transforming the user query to a vector using sentence embedding technique. Further, a k-nearest neighbors (Knn) search of user query is performed in the pod database, where the centroid of training utterances of each pod are stored. Furthermore, a preset number pods i.e. top N pods out of the one or more pods that are trained with utterances semantically closest to the query are selected based on the Knn search. Yet further, the query with expected response time is published to the top N pods out of the one or more pods. Further, the scope of responses received within the expected response time from the top N pods out of the one or more pods are assessed using at least the training utterance-intent information in the pod database. In operation, if only one response is received within the expected response time, the scope of one response is assessed, and the response is provided to the user. Further, if multiple responses are received from the top N pods within the expected response time, the scope of one or more responses may be assessed, and the most appropriate in scope response is selected using a set of predefined policies. Furthermore, the most appropriate response is provided to the user. Yet further, all further queries are subsequently transmitted to the pod providing the most suitable response until an out of scope response is received. In an embodiment of the present invention, the pod selection using the search, multicast and select technique is re-initiated if all the received responses are out of scope. Further, an out of scope response is transmitted to the user if the responses received after re-initiation of pod selection are out of scope. Furthermore, a human chat session is initiated to understand the user query. It is to the understood that all queries broadcasted/multicast to the pods are processed via AI-based micro-pods within the respective pods, and subsequently the responses are generated by the AI-based micro-pods. Further the micro-pod selection within the pods is similar to the pod selection process as explained above.

In an embodiment of the present invention, the query routed to the identified NLP resource is routed to a single pod, or one or more pods based on the select; broadcast and select; search, multicast and select techniques. Further, received query is routed to the one or more micro-pods of the corresponding pods using select; broadcast and select; search, multicast and select techniques. In operation, micro-pod which had previously served the user is selected using the micro-pod database on determination that the query is from an existing user, until an out of scope response is received from the said micro-pod. In an embodiment of the present invention, a micro-pod selection process is triggered using at least one of: a broadcast and select technique; and a search, multicast and select technique if the query is from a new user or an out of scope response is received. Further, an assessment of the number of micro-pods within the pod is performed. In an embodiment of the present invention, micro-pod selection using the broadcast and select technique is performed if the number of micro-pods associated with the pod are less than a predefined number. In an exemplary embodiment of the present invention, the predefined number is 25. In an embodiment of the present invention, the micro-pod selection using search, multicast and select technique is performed if the number of micro-pods associated with the pod are more than the predefined number.

In various embodiments of the present invention, the scope of response(s) from the one or more micro-pods during selection via broadcast and select technique and/or a search, multicast and select technique are assessed using at least the training utterance-intent information in the micro-pod database. Further, the most appropriate response from the one or more in scope responses is selected based on an analysis performed using the set of predefined policies. As already exemplified above the set of predefined policies may include one or more disambiguation policies, such as “Feeling Lucky” which chooses the first non-out of scope response from any micro-pod that responded first without waiting for a response from other micro-pods, “Most Suitable” which chooses a non-out of scope response from a micro-pod having minimum centroid of vector distance of training utterance from customer query utterance, “Most Reputed” which chooses a non-out of scope response from the micro-pod having highest rating. Subsequently, the most appropriate response is transmitted to the client computing device 102. Subsequent queries from the same user are efficiently directed to the same pod and the same Micro-pods until an out of scope response is received as already explained above. Post the out of scope response Micro-pod selection process is re-initiated at the pod-level using broadcast and select technique; and search, multicast and select technique. Further, the pod selection process is re-initiated using the broadcast and select technique; and search, multicast and select technique if the micro-pods continue to provide an out of scope response. Further, as already explained above, an out of scope response is transmitted to the user if all the responses received after re-initiation of pod selection are out of scope. In an embodiment of the present invention, the query is transmitted to a human if the re-elected pods continue to provide an out of scope response.

Advantageously, the method of the present invention, provides flexibility in scaling and descaling of the one or more domains in depth and breadth for improved natural language processing. Further, the method of the present invention, enables dynamic addition or removal of individual AI-based units and Micro-units at run time without impacting the overall system. Furthermore, the method of the present invention, reduces response time and enhances precision in processing of the natural language queries, as the queries can be directly serviced by appropriate AI-based units and Micro-units.

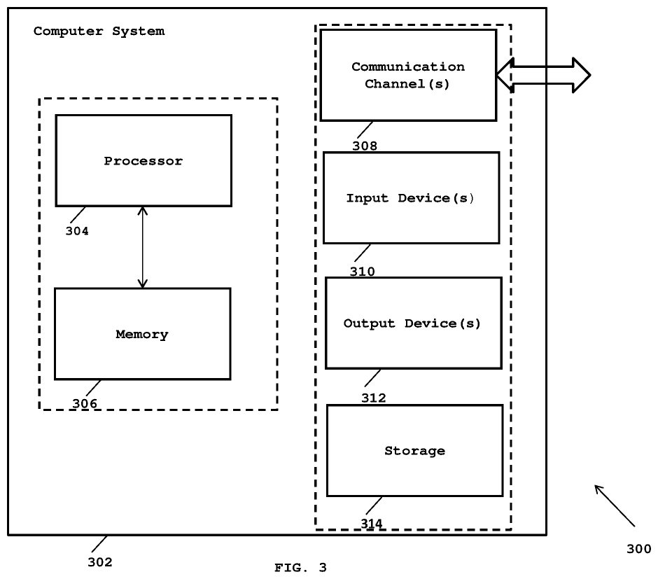

FIG. 3 illustrates an exemplary computer system in which various embodiments of the present invention may be implemented.

The computer system 302 comprises a processor 304 and a memory 306. The processor 304 executes program instructions and is a real processor. The computer system 302 is not intended to suggest any limitation as to scope of use or functionality of described embodiments. For example, the computer system 302 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 306 may store software for implementing various embodiments of the present invention. The computer system 302 may have additional components. For example, the computer system 302 includes one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various softwares executing in the computer system 302, and manages different functionalities of the components of the computer system 302.

The communication channel(s) 308 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 310 may include, but not limited to, a keyboard, mouse, pen, joystick, trackball, a voice device, a scanning device, touch screen or any another device that is capable of providing input to the computer system 302. In an embodiment of the present invention, the input device(s) 310 may be a sound card or similar device that accepts audio input in analog or digital form. The output device(s) 312 may include, but not limited to, a user interface on CRT or LCD, printer, speaker, CD/DVD writer, or any other device that provides output from the computer system 302.

The storage 314 may include, but not limited to, magnetic disks, magnetic tapes, CD-ROMs, CD-RWs, DVDs, flash drives or any other medium which can be used to store information and can be accessed by the computer system 302. In various embodiments of the present invention, the storage 314 contains program instructions for implementing the described embodiments.

The present invention may suitably be embodied as a computer program product for use with the computer system 302. The method described herein is typically implemented as a computer program product, comprising a set of program instructions which is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention.

We claim:

1. A method for providing natural language processing of queries associated with one or more domains, wherein the method is implemented by at least one processor executing program instructions stored in a memory, the method comprising:
hosting, by the processor, one or more Natural Language Processing(NLP) resources, each NLP resource configurable to perform natural language processing of queries associated with respective one or more domains and emulate responses associated with the respective one or more domains, wherein each NLP resource comprises logically independent one or more AI-based units, each AI-based unit individually configurable to perform natural language processing of queries and emulate responses associated with respective one or more subdomains further associated with the one or more domains of the corresponding NLP resource, such that individual configuring of the one or more AI-based units causes the configuring of the corresponding NLP resource without affecting overall configuration of the corresponding NLP resource; and
performing, by the processor, natural language processing of an incoming query and generating a response via the one or more NLP resources.

2. The method as claimed in claim 1, wherein the one or more AI-based units are decentralized, and connected to the corresponding NLP resource using adapter patterns.

3. The method as claimed in claim 1, wherein the one or more AI-based units comprise respective logically independent one or more AI-based micro-units, each AI-based micro-unit individually configurable to perform natural language processing of queries and emulate responses for respective one or more topics further associated with the one or more subdomains of the corresponding AI-based unit, wherein individual configuring of the one or more AI-based micro-units enables the configuring of the corresponding AI-based unit.

4. The method as claimed in claim 3, wherein the one or more AI-based micro-units are decentralized and independently scalable, wherein further, the one or more AI-based micro-units are connected to the corresponding AI-based unit using adapter patterns.

5. The method as claimed in claim 1, wherein the one or more AI-based units are configured to support same or different classes of natural language processing, wherein the classes include Conversational class, Frequently Asked Question (FAQ), Question and Answer, Semantic Search, and Knowledge Graph.

6. The method as claimed in claim 1, wherein performing natural language processing of the incoming query and generating the response via the one or more NLP resources comprises identifying one of the one or more NLP resources based on a mapping between a system meta-data and an information associated with the incoming query.

7. The method as claimed in claim 6, wherein the system meta-data comprises names of each of the one or more NLP resources, domain of each of the one or more NLP resources, resource identifier of each of the one or more NLP resources, identifiers of supported channels of the one or more NLP resources, serving matrix, resilience rating for the one or more NLP resource and data classification ratings of the one or more NLP resource.

8. The method as claimed in claim 6, wherein the information associated with the incoming query comprises at least one of: a domain and a resource identifier.

9. The method as claimed in claim 1, wherein performing natural language processing of the incoming query and generating the response via the one or more NLP resources comprises identifying one of the one or more NLP resources, and performing natural language processing of the incoming query and generating the response via the one or more AI-based units corresponding to the identified NLP resource using at least one of: details stored in a pod-database of the identified NLP resource, a broadcast and select technique, and a search, multicast and select technique along with a set of predefined policies.

10. The method as claimed in claim 9, wherein performing natural language processing of the incoming query and generating the response via the one or more AI-based units comprises:
performing an assessment to determine if the incoming query is from a new user or an existing user by analyzing user-session details in the pod-database of the identified NLP resource;
selecting an AI-based unit out of the one or more AI-based units which previously serviced user of the incoming query on determination that the incoming query is from an existing user;
assessing a scope of response received from the selected AI-based unit; and
routing all incoming queries from the user to the selected AI-based unit unless an out of scope response is received.

11. The method as claimed in claim 10, wherein the broadcast and select technique; and the search, multicast and select technique is triggered based on at least one of: the determination that the incoming query is from a new user, and on receiving an out of scope response from the selected AI-based unit.

12. The method as claimed in claim 11, wherein the broadcast and select technique; and a search, multicast and select technique is triggered based on an assessment of a number of AI-based units associated with the identified NLP resource, wherein further, a selection of an AI-based unit using the broadcast and select technique is performed if the number of AI-based units are less than a predefined number, and the selection using search, multicast and select technique is performed if the number of AI-based units are more than the predefined.

13. The method as claimed in claim 9, wherein performing natural language processing of the incoming query and generating the response via the one or more AI-based units using the broadcast and select technique comprises: publishing the incoming query with expected response time to each of the one or more AI-based units of the identified NLP resource;
assessing scope of responses received within the expected response time from the one or more AI-based units, wherein the scope of one response is assessed if only one response is received within the expected response time;
selecting most appropriate non-out of scope response out of the one or more non-out of scope responses using the set of predefined policies for transmission to the user of the incoming query; and
performing natural language processing of all incoming queries from the same user via the AI-based unit providing the most suitable response, until an out of scope response is generated by said AI-based unit.

14. The method as claimed in claim 13, wherein selecting an AI-based unit via the broadcast and select technique is re-initiated if the response received from the AI-based unit providing the most suitable response is out of scope, wherein further, an out of scope response is transmitted to the user of the incoming query if all responses received after the re-initiation are out of scope; and a human chat session is initiated by transferring the incoming query to a technical group.

15. The method as claimed in claim 9, wherein the set of predefined policies comprises one or more disambiguation policies, selected from a group comprising:
Feeling Lucky, which chooses first non-out of scope response from any AI-based unit out of the one or more AI-based units of the identified NLP resource that responded first without waiting for a response from other AI-based units;
Most Suitable, which chooses a non-out of scope response from an AI-based unit out of the one or more AI-based units having minimum centroid of vector distance of training utterance from the incoming query utterance; and
Most Reputed, which chooses a non-out of scope response from an AI-based unit out of the one or more AI-based units of the identified NLP resource having highest rating.

16. The method as claimed in claim 9, wherein performing natural language processing of the incoming query and generating the response via the one or more AI-based units using the search, multicast and select technique comprises:
transforming the incoming query to a vector using sentence embedding technique;
performing a k-nearest neighbors (Knn) search of the incoming query in the pod database, where centroid of training utterances of each AI-based unit are stored;
selecting a preset number of AI-based units out of the one or more AI-based units that are trained with utterances semantically closest to the incoming query based on the Knn search;
publishing the incoming query with expected response time to each of the selected preset number of AI-based units;
assessing scope of responses received within the expected response time from the selected preset number of AI-based units, wherein the scope of one response is assessed if only one response is received within the expected response time;
selecting most appropriate non-out of scope response out of the one or more non-out of scope responses using the set of predefined policies for transmission to the user of the incoming query; and
performing natural language processing of all incoming queries from the same user via the AI-based unit providing the most suitable response, until an out of scope response is generated by said AI-based unit.

17. The method as claimed in claim 3, wherein performing natural language processing of the incoming query and generating the response via the one or more NLP resources comprises identifying one of the one or more NLP resources, and performing natural language processing of the incoming query and generating the response via the one or more AI-based units corresponding to the identified NLP resource using at least one of: details stored in a pod-database of the identified NLP resource, a broadcast and select technique, and a search, multicast and select technique along with a set of predefined policies, further, wherein the natural language processing of the incoming query and generation of the response is performed via the one or more AI-based micro-units corresponding to the one or more AI-based units using at least one of: details stored in respective micro-pod database associated with the one or more AI-based units, a broadcast and select technique, and a search, multicast and select technique along with the set of predefined policies.

18. A system for providing natural language processing of queries associated with one or more domains, the system comprising:
a memory storing program instructions; a processor configured to execute program instructions stored in the memory; and a natural language processing engine executed by the processor, and configured to:
host one or more Natural Language Processing(NLP) resources, each NLP resource configurable to perform natural language processing of queries associated with respective one or more domains and emulate responses associated with the respective one or more domains, wherein each NLP resource comprises logically independent one or more AI-based units, each AI-based unit individually configurable to perform natural language processing of queries associated with respective one or more subdomains further associated with the one or more domains of the corresponding NLP resource and emulate responses associated with the respective one or more sub-domains based on the natural language processing, such that individual configuring of the one or more AI-based units causes the configuring of the corresponding NLP resource without affecting overall configuration of the corresponding NLP resource; and
perform natural language processing of an incoming query and generate a response via the one or more NLP resources.

19. The system as claimed in claim 18, wherein the one or more AI-based units are decentralized, wherein further the one or more AI-based units comprise respective logically independent one or more AI-based micro-units, each AI-based micro-unit individually configurable to perform natural language processing of queries associated with respective one or more topics further associated with the one or more subdomains of the corresponding AI-based unit and emulate responses associated with the respective one or more topics based on the natural language processing, wherein individual configuring of the one or more AI-based micro-units to perform natural language processing and emulate responses of queries of the respective one or more topics enables the configuring of the corresponding AI-based unit to perform natural language processing and emulate responses of queries of the respective one or more subdomains.

20. The system as claimed in claim 18, wherein each of the one or more AI-based units comprise individual input/output addresses, a pod broadcast address and a pod multicast address to receive the incoming query and output a response.

21. The system as claimed in claim 19, wherein the one or more AI-based units and the one or more AI-based micro-units are configured to support same or different classes of natural language processing, wherein the classes include Conversational class, Frequently Asked Question (FAQ), Question and Answer, Semantic Search, and Knowledge Graph.

22. The system as claimed in claim 18, wherein the natural language processing engine comprises an interface unit executed by the processor, said interface unit configured to facilitate communication with a client computing device, an enterprise application, and an admin input/output device.

23. The system as claimed in claim 18, wherein the natural language processing engine comprises a routing unit executed by the processor, said routing unit configured to identify one of the one or more NLP resources for performing natural language processing of the incoming query and generating the response based on a mapping between a system meta-data and an information associated with the incoming query.

24. The system as claimed in claim 23, wherein the routing unit is configured to maintain the system meta-data, said system meta-data comprising names of each of the one or more NLP resources, domain of each of the one or more NLP resources, resource identifier of each of the one or more NLP resources, identifiers of supported channels of the one or more NLP resources, serving matrix, resilience rating for the one or more NLP resource, Data classification rating of the one or more NLP resource.

25. The system as claimed in claim 18, wherein performing natural language processing of the incoming query and generating the response via the one or more NLP resources comprises:
identifying one of the one or more NLP resources, and performing natural language processing of the incoming query and generating the response via the one or more AI-based units corresponding to the identified NLP resource using at least one of: details stored in a pod-database of the identified NLP resource, a broadcast and select technique, and a search, multicast and select technique along with a set of predefined policies.

26. The system as claimed in claim 25, wherein performing natural language processing of the incoming query and generating the response via the one or more AI-based units comprises:
performing an assessment to determine if the incoming query is from a new user or an existing user by analyzing user-session details in the pod-database of the identified NLP resource;
selecting an AI-based unit out of the one or more AI-based units which previously serviced user of the incoming query on determination that the incoming query is from an existing user;
assessing a scope of response received from the selected AI-base unit; and
routing all incoming queries from the user to the selected AI-based unit unless an out of scope response is received.

27. The system as claimed in claim 26, wherein the broadcast and select technique; and the search, multicast and select technique is triggered based on at least one of: the determination that the incoming query is from a new user, and on receiving an out of scope response from the selected AI-based unit.

28. The system as claimed in claim 25, wherein performing natural language processing of the incoming query and generating the response via the one or more AI-based units using the broadcast and select technique comprises: publishing the incoming query with expected response time to each of the one or more AI-based units of the identified NLP resource;
assessing scope of responses received within the expected response time from the one or more AI-based units;
selecting most appropriate non-out of scope response out of the one or more non-out of scope responses using the set of predefined policies for transmission to the user of the incoming query; and
performing natural language processing of all incoming queries from the same user via the AI-based unit providing the most suitable response, until an out of scope response is generated by said AI-based unit.

29. The system as claimed in claim 25, wherein performing natural language processing of the incoming query and generating the response via the one or more AI-based units using the search, multicast and select technique comprises:
transforming the incoming query to a vector using sentence embedding technique;
performing a k-nearest neighbors (Knn) search of the incoming query in the pod database, where centroid of training utterances of each AI-based unit are stored;
selecting a preset number of AI-based units out of the one or more AI-based units that are trained with utterances semantically closest to the incoming query based on the Knn search;
publishing the incoming query with expected response time to each of the selected preset number of AI-based units;
assessing scope of responses received within the expected response time from the selected preset number AI-based units, wherein the scope of one response is assessed if only one response is received within the expected response time;
selecting most appropriate non-out of scope response out of the one or more non-out of scope responses using the set of predefined policies for transmission to the user of the incoming query; and
performing natural language processing of all incoming queries from the same user via the AI-based unit providing the most suitable response, until an out of scope response is generated by said AI-based unit.

30. The system as claimed in claim 29, wherein selecting an AI-based unit via search, multicast and select technique is re-initiated if the response received from the AI-based unit providing the most suitable response is out of scope, wherein further, an out of scope response is transmitted to the user of the incoming query if all responses received after the re-initiation are out of scope; and a human chat session is initiated by transferring the incoming query to a technical group.

31. The system as claimed in claim 19, wherein performing natural language processing of the incoming query and generating the response via the one or more NLP resources comprises:
identifying one of the one or more NLP resources, and performing natural language processing of the incoming query and generating the response via the one or more AI-based units corresponding to the identified NLP resource using at least one of: details stored in a pod-database of the identified NLP resource, a broadcast and select technique, and a search, multicast and select technique along with a set of predefined policies, further, wherein the natural language processing of the incoming query and generation of the response is performed via the one or more AI-based micro-units associated with the one or more AI-based units using at least one of: details stored in respective micro-pod database associated with the one or more AI-based units, a broadcast and select technique, and a search, multicast and select technique along with the set of predefined policies.

32. A computer program product comprising:
a non-transitory computer-readable medium having computer-readable program code stored thereon, the computer-readable program code comprising instructions that, when executed by a processor, cause the processor to:
host one or more Natural Language Processing(NLP) resources, each NLP resource configurable to perform natural language processing of queries associated with respective one or more domains and emulate responses associated with the respective one or more domains, wherein each NLP resource comprises logically independent one or more AI-based units, each AI-based unit individually configurable to perform natural language processing of queries associated with respective one or more subdomains further associated with the one or more domains of the corresponding NLP resource and emulate responses associated with the respective one or more sub-domains based on the natural language processing, such that individual configuring of the one or more AI-based units causes the configuring of the corresponding NLP resource without affecting overall configuration of the corresponding NLP resource; and
perform natural language processing of an incoming query and generate a response via the one or more NLP resources.
